(19) United States
(12) Patent Application Publication
(10) Pub. No.: US 2025/0214877 A1
(43) Pub. Date: Jul. 3, 2025

(54) WASTE RECLAMATION SYSTEM AND METHOD

(71) Applicants: BWXT Medical Ltd., Ottawa (CA); BWXT NOG Technologies, Inc., Lynchburg, VA (US)

(72) Inventors: Bryan Blake WIGGINS, Forest, VA (US); Harley Thomas HODGES, Concord, VA (US); Stephen M. OELSNER, Carleton Place (CA)

(21) Appl. No.: 19/001,698

(22) Filed: Dec. 26, 2024

Related U.S. Application Data
(60) Provisional application No. 63/615,974, filed on Dec. 29, 2023.

(51) Int. Cl. C02F 9/00; C02F 1/00; C02F 1/28; C02F 1/42; C02F 1/52; C02F 101/20

(52) U.S. Cl. CPC C02F 9/00; C02F 1/004; C02F 1/283; C02F 1/42; C02F 1/5245; C02F 2101/20; C02F 2201/006

(57) ABSTRACT

A system and method for waste reclamation by which dissolved molybdenum (Mo) is reclaimed and heavy metals are filtered from process wash water containing Mo for onsite disposal. The system and method reduces byproduct cost by converting liquid byproduct to solid byproduct, while converting dissolved Mo in solution into a solid form capable of being converted to base metal.

### CROSS-REFERENCE TO RELATED APPLICATION

This application claims priority from U.S. Provisional Patent Application No. 63/615,974 filed on Dec. 29, 2023, in the United States Patent and Trademark Office. The disclosure of which is incorporated herein by reference in its entirety.

### FIELD OF THE INVENTION

The present invention relates to a waste reclamation system and method, particularly a waste reclamation system and method that can be deployed in a radiation sensitive environment.

### BACKGROUND OF THE INVENTION

Process wastewater in certain nuclear facilities may contain up to 2000 ppm of molybdenum (Mo) prior to discharge. There is a need to find a way to process the waste rather than disposal of non-hazardous waste in bulk.

There is also a need for a system and method that can be deployed in a radiation sensitive environment and could further reduce production costs. There is a need for a system and method where the water can be returned to a municipal water system.

The system and method of the present invention meets these needs.

### SUMMARY OF THE INVENTION

The present invention relates to a system and method for waste reclamation by which dissolved molybdenum (Mo) is reclaimed and heavy metals are filtered from process wash water containing Mo for onsite disposal. The system and method reduces byproduct cost by converting liquid byproduct to solid byproduct, while converting dissolved Mo in solution into a solid form that could then be converted to base metal.

In accordance with an aspect of the present invention, a method for waste reclamation is provided, the method comprising: measuring a concentration of molybdenum (Mo) in a liquid byproduct; adding to the liquid byproduct a salt or other water soluble compound containing an element selected from the group consisting of mercury, lead, thorium, sulfur, and a combination thereof; mixing until substantially all or all of the salt or the water soluble compound is dissolved in solution; allowing a period of time for the solution to precipitate thereby forming process water precipitation; and passing the process water precipitation through a guard filter or an activated carbon column to filter out a MoO₄ containing compound.

In accordance with an aspect of the present invention, the method further comprises passing process flow exiting from the guard filter or the activated carbon column through a first filter cartridge containing a first mechanical filter or filter media.

In accordance with an aspect of the present invention, the first mechanical filter or filter media is a rust and sediment filter.

In accordance with an aspect of the present invention, the method further comprises filtering flow from the first filter cartridge through a second filter cartridge containing a second mechanical filter or filter media.

In accordance with an aspect of the present invention, the second mechanical filter or filter media is drinking water filter pellets.

In accordance with an aspect of the present invention, the method further comprises passing flow from the second filter cartridge through a third filter cartridge packed with Al₂O₃.

In accordance with an aspect of the present invention, the Al₂O₃ is present in an alumina powder bed.

In accordance with an aspect of the present invention, the method further comprises passing flow from the third filter cartridge packed with Al₂O₃ through a fourth cartridge packed with sandstone sediment to filter the water and catch alumina fines.

In accordance with an aspect of the present invention, the method further comprises passing flow through a chromatography column filled with an ion exchange resin to remove remaining soluble metal species. In accordance with an aspect of the present invention, the ion exchange resin is a chitosan-based ion exchange resin.

In accordance with an aspect of the present invention, the method further comprises passing flow from the third filter cartridge packed with Al₂O₃ through an ion exchange resin to remove soluble metal species. In accordance with an aspect of the present invention, the ion exchange resin is a chitosan-based ion exchange resin.

In accordance with an aspect of the present invention, a method for waste reclamation is provided, the method comprising: measuring a concentration of molybdenum (Mo) in a liquid byproduct; adding to the liquid byproduct a salt or other water soluble compound containing an element selected from the group consisting of mercury, lead, thorium, sulfur, and a combination thereof; mixing until substantially all or all of the salt or the water soluble compound is dissolved in solution; allowing a period of time for the solution to precipitate thereby forming process water precipitation; passing the process water precipitation through a guard filter or an activated carbon column to filter out a MoO₄ containing compound; and converting Mo from solid byproduct into base metal.

In accordance with an aspect of the present invention, a method for waste reclamation is provided, the method comprising: measuring a concentration of molybdenum (Mo) in a liquid byproduct; adding CaCl₂) to the liquid byproduct; mixing until substantially all or all of the CaCl₂) is dissolved in solution; allowing a period of time for the solution to precipitate forming process water precipitation; and passing the process water precipitation through a guard filter or an activated carbon column to filter out CaMoO₄.

In accordance with an aspect of the present invention, the method further comprises passing process flow exiting from the guard filter or the activated carbon column through a first filter cartridge containing a first mechanical filter or filter media. In accordance with an aspect of the present invention, the first mechanical filter or filter media is a rust and sediment filter.

In accordance with an aspect of the present invention, the method further comprises filtering flow from the first filter cartridge through a second filter cartridge containing a second mechanical filter or filter media. In accordance with an aspect of the present invention, the second mechanical filter or filter media is drinking water filter pellets.

In accordance with an aspect of the present invention, the method further comprises passing flow from the second filter cartridge through a third filter cartridge packed with Al₂O₃.

In accordance with an aspect of the present invention, the method further comprises passing flow from the second filter cartridge through a third filter cartridge packed with Al₂O₃. In accordance with an aspect of the present invention, the Al₂O₃ is present in an alumina powder bed.

In accordance with an aspect of the present invention, the method further comprises passing flow from the third filter cartridge packed with Al₂O₃ through a fourth cartridge packed with sandstone sediment to filter the water and catch alumina fines.

In accordance with an aspect of the present invention, the method further comprises passing flow through a chromatography column filled with an ion exchange resin to remove soluble metal species. In accordance with an aspect of the present invention, the ion exchange resin is a chitosan-based ion exchange resin.

In accordance with an aspect of the present invention, the method further comprises passing flow from the third filter cartridge packed with Al₂O₃ through an ion exchange resin to remove soluble metal species. In accordance with an aspect of the present invention, the ion exchange resin is a chitosan-based ion exchange resin.

In accordance with an aspect of the present invention, a method for waste reclamation is provided, the method comprising: measuring a concentration of molybdenum (Mo) in a liquid byproduct; adding CaCl₂) to the liquid byproduct; mixing until substantially all or all of the CaCl₂) is dissolved in solution; allowing a period of time for the solution to precipitate forming process water precipitation; passing the process water precipitation through a guard filter or an activated carbon column to filter out CaMoO₄; and converting Mo from solid byproduct into base metal.

With the system and process of the present invention, approximately 50 to 100 gallons can be processed per day. Chemical precipitation of wastewater can reduce Mo content below 100 ppm. Post precipitation, the liquid stream is filtered using mechanical media. The liquid stream is also optionally subjected to ion exchange, in the form of activated alumina and organic resin to reduce the final Mo concentration between 5 ppm to 40 ppm. Flow rates of post precipitation processing can be approximately 0.25 gallons per minute. Samples can be taken after each stage. Ion exchange steps are repeated until Mo levels are below that required by CFR 433.17 for discharge. At this stage, a final sample is taken as retain and the bulk liquid can be batch discharged to a municipal sewer.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 illustrates a process water reclamation system and method comprising a small-scale filtration flow path in accordance with an aspect of the present invention.

FIG. 2 illustrates a process water reclamation system and method comprising a large-scale filtration flow path in accordance with an aspect of the present invention.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

The system and method of the present invention reduces byproduct cost by converting liquid byproduct to solid byproduct, while converting dissolved molybdenum (Mo) in solution into a solid form that could then be converted to base metal. Additionally, this system and method can be deployed in a radiation sensitive environment and could further reduce production costs.

In an aspect of the invention, the method comprises collecting liquid byproduct liquid and measuring the concentration of Molybdenum (Mo) in the liquid byproduct. Using the measured Mo concentration, a salt (including but not limited to calcium chloride) or other water soluble compound containing an element selected from the group consisting of mercury, lead, thorium, sulfur, and a combination thereof, is added to the byproduct liquid to form a solution and allowed to mix for a period of time.

For example, in the case of calcium chloride (CaCl₂)), a minimum of 3:1 molar ratio of CaCl₂) to Mo is added into the process water barrel (e.g., 1000 ppm Mo needs ˜1.5 kg of CaCl₂)).

Mixing of the waste and solution can occur using a fixed blade impeller powered by a brushless drill. Mixing occurs until substantially all or all of the salt or the water soluble compound is dissolved. The amount of time may vary but can typically be approximately 2 to 3 minutes.

The method further comprises allowing the solution to precipitate. Upon inspection, the solution becomes slightly cloudy with white particulates. After mixing for a longer period of time, for example, more CaMoO₄ is precipitated. The precipitation of calcium molybdate (CaMoO₄) occurs when a molybdate anion (MoO₄-2) and calcium cation (Ca²⁺) are combined in solution. Using CaCl₂) with ammonium molybdate ((NH₄)₂MoO₄), CaMoO₄ can be precipitated.

This solution of MoO₄ containing compound and remaining byproduct liquid, also referred to herein as the “process water precipitation,” is filtered through a process water reclamation system comprising filtration.

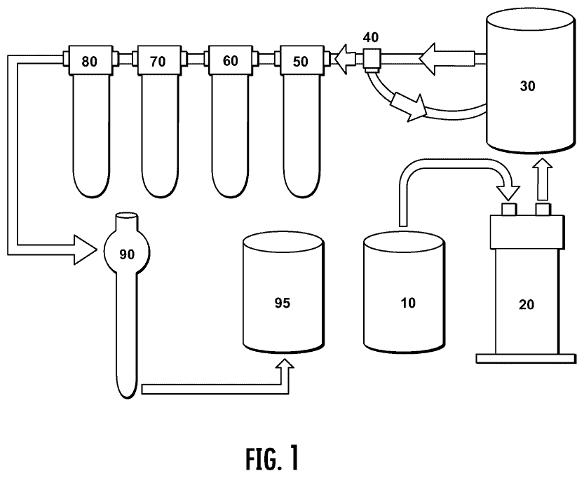

Referring to the figures, FIG. 1 illustrates the process water reclamation system and method of the present invention comprising a small-scale filtration flow path. As shown in FIG. 1, in the example case where calcium chloride is employed, the process water precipitation from a precipitation tank 10 is pumped through an activated carbon column 20 to filter out CaMoO₄ into a holding tank 30. From there the water goes through a pressure relief valve 40 and is filtered through multiple cartridges such as a set of four cartridges, as shown, using a diaphragm pump. Two flow streams exit pressure relief valve 40, one returns to a holding tank 30 and the other flows into a first filter cartridge. The first cartridge is a rust and sediment filter 50, the second cartridge is a drinking water filter pellets 60, both of which were acting as mechanical filters for any residual CaMoO₄. The third cartridge is packed with Al₂O₃ 70 that sequesters more of the remaining soluble metal species found in the byproduct liquid, and the fourth cartridge is packed with sandstone sediment 80 to filter the water further as well as to catch any alumina fines that made it through the previous cartridge. After filtering through all four cartridges, the water is then optionally pumped through a chromatography column filled with a chitosan-based ion exchange resin 90 to remove any remaining small quantities of soluble metal species. The exiting flow stream enters a discharge tank 95.

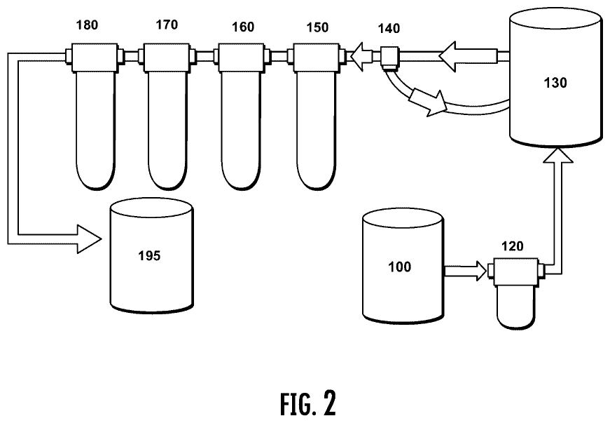

FIG. 2 illustrates the process water reclamation system and method comprising a large-scale filtration flow path in accordance with an aspect of the present invention. As shown in FIG. 2, in the example case where calcium chloride is employed, process water precipitation is pumped from a precipitation tank 100 through a guard filter 120 (such as 50-μm) into a holding tank 130 to isolate the liquid from the solids that settled out. Guard filter 120 is placed inline during the transfer to catch any CaMoO₄ that was pulled through. From holding tank 130, the solution is then pumped through a pressure relief valve 140 and through multiple filter cartridges. Two flow streams exit pressure relief valve 140, one returns to holding tank 130 and the other flows into a first filter cartridge which is a rust and sediment cartridge 150. A second cartridge has a mixture of resin with γAl₂O₃ pellets 160 as a filler bed to keep the resin in place, as well as act as another sorbent for dissolved metals. A third cartridge has an alumina powder bed 170. A fourth optional cartridge is filled with an ion exchange resin 180 as well as γAl₂O₃ pellets to keep the resin properly packed. The exiting flow enters a discharge tank 195.

### Example

Approximately 4.5 gallons (17 L) of byproduct liquid was collected in a 5-gallon bucket for testing. Two hundred grams of CaCl₂) was added to the 5-gallon bucket and allowed to mix for 10 minutes. Upon inspection, a white film began to coat the walls of the bucket, and the solution became slightly cloudy with white particulates. After mixing overnight, more CaMoO₄ had precipitated. This solution of CaMoO₄ and remaining byproduct liquid was then sampled and filtered through a filtration system prototype for further testing.

A full-scale precipitation was run using 40 gallons of byproduct liquid collected as the small-scale test. Byproduct liquid came from three different batches to simulate full pilot process water production. A semi-quantitative measurement of the starting Mo concentration was taken. Using concentrated sodium hydroxide (NaOH), the pH was adjusted to 7.5. Using the estimated concentration, a 3:1 ratio (˜1.5 kg) of CaCl₂ to Mo was then added to the 40-gallon (151 L) barrel of byproduct liquid while mixing. After 3 to 5 minutes of mixing, the pH of the solution had decreased to 6.4. The barrel of process water was mixed for 3 to 4 hours before allowing solids to settle overnight. The solution was not mixed for a minimum of 12 hours. The solution was clear with all the precipitated CaMoO₄ settled in the bottom of the barrel. The water was then carefully pumped into a holding barrel for further processing through the filtration system.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A method for waste reclamation, the method comprising:
measuring a concentration of molybdenum (Mo) in a liquid byproduct;
adding to the liquid byproduct a salt or other water soluble compound containing an element selected from the group consisting of mercury, lead, thorium, sulfur, and a combination thereof;
mixing until substantially all or all of the salt or the water soluble compound is dissolved in solution;
allowing a period of time for the solution to precipitate thereby forming process water precipitation; and
passing the process water precipitation through a guard filter or an activated carbon column to filter out a MoO₄ containing compound.

2. The method according to claim 1, further comprising passing process flow exiting from the guard filter or the activated carbon column through a first filter cartridge containing a first mechanical filter or filter media.

3. The method according to claim 2, wherein the first mechanical filter or filter media is a rust and sediment filter.

4. The method according to claim 2, further comprising filtering flow from the first filter cartridge through a second filter cartridge containing a second mechanical filter or filter media.

5. The method according to claim 4, wherein the second mechanical filter or filter media is drinking water filter pellets.

6. The method according to claim 4, further comprising passing flow from the second filter cartridge through a third filter cartridge packed with Al₂O₃.

7. The method according to claim 6, wherein the Al₂O₃ is present in an alumina powder bed.

8. The method according to claim 6, further comprising passing flow from the third filter cartridge packed with Al₂O₃ through a fourth cartridge packed with sandstone sediment to filter the water and catch alumina fines.

9. The method according to claim 8, further comprising passing flow through a chromatography column filled with an ion exchange resin to remove remaining soluble metal species.

10. The method according to claim 9, wherein the ion exchange resin is a chitosan-based ion exchange resin.

11. The method according to claim 1, further comprising converting Mo from solid byproduct into base metal.

12. The method according to claim 6, further comprising passing flow from the third filter cartridge packed with Al₂O₃ through an ion exchange resin to remove soluble metal species.

13. The method according to claim 12, wherein the ion exchange resin is a chitosan-based ion exchange resin.

14. A method for waste reclamation, the method comprising:
measuring a concentration of molybdenum (Mo) in a liquid byproduct;
adding CaCl₂) to the liquid byproduct;
mixing until substantially all or all of the CaCl₂) is dissolved in solution;
allowing a period of time for the solution to precipitate forming process water precipitation; and
passing the process water precipitation through a guard filter or an activated carbon column to filter out CaMoO₄.

15. The method according to claim 14, further comprising passing process flow exiting from the guard filter or the activated carbon column through a first filter cartridge containing a first mechanical filter or filter media.

16. The method according to claim 15, wherein the first mechanical filter or filter media is a rust and sediment filter.

17. The method according to claim 15, further comprising filtering flow from the first filter cartridge through a second filter cartridge containing a second mechanical filter or filter media.

18. The method according to claim 17, wherein the second mechanical filter or filter media is drinking water filter pellets.

19. The method according to claim 17, further comprising passing flow from the second filter cartridge through a third filter cartridge packed with Al₂O₃.

20. The method according to claim 19, wherein the Al₂O₃ is present in an alumina powder bed.

21. The method according to claim 19, further comprising passing flow from the third filter cartridge packed with Al₂O₃ through a fourth cartridge packed with sandstone sediment to filter the water and catch alumina fines.

22. The method according to claim 21, further comprising passing flow through a chromatography column filled with an ion exchange resin to remove soluble metal species.

23. The method according to claim 22, wherein the ion exchange resin is a chitosan-based ion exchange resin.

24. The method according to claim 14, further comprising converting Mo from solid byproduct into base metal.

25. The method according to claim 19, further comprising passing flow from the third filter cartridge packed with Al₂O₃ through an ion exchange resin to remove soluble metal species.

26. The method according to claim 25, wherein the ion exchange resin is a chitosan-based ion exchange resin.
